(19) United States
(12) Patent Application Publication
(10) Pub. No.: US 2022/0013034 A1
(43) Pub. Date: Jan. 13, 2022

(54) Integrated Video Interface Method and System

(71) Applicant: Abraham Varon Weinryb, Waltham, MA (US)

(72) Inventor: Abraham Varon Weinryb, Waltham, MA (US)

(21) Appl. No.: 17/361,390

(22) Filed: Jun. 29, 2021

Related U.S. Application Data
(60) Provisional application No. 63/080,710, filed on Sep. 19, 2020.
(60) Provisional application No. 63/076,836, filed on Sep. 10, 2020.
(60) Provisional application No. 63/045,333, filed on Jun. 29, 2020.

(51) Int. Cl. G09B 19/00; H04N 5/232; G09B 5/04; G09B 5/02

(52) U.S. Cl. CPC G09B 19/00; G09B 5/02; G09B 5/04; H04N 5/23222

(57) ABSTRACT

The current invention relates to data flow of video streaming, to user instructions' transfer between two computing devices over the internet and to a man machine interface in which a feedback is provided relating to the quality of such interactions and related video products. The invention introduces new ways to improve video streaming quality and to train users for the purpose of achieving better results of video capturing.

### CROSS REFERENCE TO RELATED APPLICATIONS

This application claims benefit of provisional application 63/080,710 filed on Sep. 19, 2020.

This application claims benefit of provisional application 63/076,836 filed on Sep. 10, 2020.

This application claims benefit of provisional application 63/045,333 filed on Jun. 29, 2020.

### FIELD OF THE INVENTION

The field of the invention relates to data flow of video streaming, to user instructions' transfer between two computing devices over the internet and to a man machine interface in which a feedback is provided relating to the quality of such interactions and related video products. The invention introduces new ways to improve video streaming quality and to train users for the purpose of achieving better results of video capturing.

### BACKGROUND OF THE INVENTION

In my Provisional application named “Visit Via Taker Method and System”, U.S. 63/045,333 dated Jun. 29, 2020, a system and method of video streaming and of services via the internet is claimed. In my additional Provisional application named “Instant Ideograms Method and System”, U.S. 63/076,836 dated Sep. 10, 2020, an innovative and efficient way to transfer instructions over the internet with a specific implementation relating to video streaming over the internet is claimed. According to U.S. 63/045,333, a Customer (also named a Visitor) interacts with a Taker which “takes” the customer for a visit. The Taker can virtually take the Customer to any place in the world, at any date and time. The Visitor is not only passively taken wherever the Taker goes, but also actively instructs the Taker where to go, and such instructions may include the U.S. 63/045,836 Method and System. The quantum leap in the integration between the virtual world and the real world, as derived from both said U.S. 63/076,836 and U.S. 63/045,333 can be further enhanced according to the current invention, by means which will result in improving and optimizing the streaming video of U.S. 63/045,333 and, as a result, increasing the level of satisfaction of both the Visitor and the Taker.

It is therefore an object of the present invention to provide a method and system to instruct and teach the Taker how to improve the quality of said streaming video and how to make the Visitor as pleased as possible with said streaming video, further named also as the Video Product, by providing suggestions and comments to the Taker while streaming.

It is therefore an object of the present invention to provide a method and system to instruct and teach the Taker how to improve the quality of said streaming video by providing a set of suggestions and comments to the Taker after a Visit has ended, as guidelines towards the next Visits.

### SUMMARY OF THE INVENTION

The invention relates to a computer implemented method for providing automated feedback to a person who generates Video Products, so that said automated feedback may help said person to improve his Video Products, comprising the elements of: (a) A Video Product generated by said person; (b) Reference data relating to said Video Product and originated from at least one source; (c) Analyzer which correlates elements of (a) with corresponding elements of (b) in order to generate Automated Feedback Conclusions (AFC); and (d) Means to collect said AFC and provide them to said person when needed as Automated Feedback Instructions (AFI).

Preferably, said method is implemented on-the-fly, therefore it provides said person with Automated Feedback Instructions relating to a previous part of said Video Product while said person is generating additional parts of said Video Product.

Preferably, said Automated Feedback Instructions are provided to said person after completing a video Product so that said person can implement said Automated Feedback Instructions when generating next Video Products.

Preferably, said source of reference data is Instant Ideogram instructions provided to said person over the internet by another person.

Preferably, said source of reference data is oral instructions provided to said person over the internet by another person.

Preferably, said source of reference data is text instructions provided to said person over the internet by another person.

Preferably, said source of reference data is data from the sensors of a mobile device of said person, which is used to generate the Video Product.

Preferably, said source of reference data is data from the GPS of a mobile device of said person which is used to generate the Video Product.

Preferably, said source of reference data is computer code's analysis of the Video Variables of the Video Product itself.

Preferably, said improvement of Video Product leads to higher automated scoring for said person.

Preferably, said person is a Taker and said source is a Visitor and said reference data is the instructions provided by the visitor to the Taker.

Preferably, said improvement of Video Product leads to higher score granted by said Visitor to said Taker.

Preferably, said Automated Feedback Instructions are provided to said person via automated digital voice.

Preferably, said Automated Feedback Instructions are provided to said person via automated text.

Preferably, said Automated Feedback Instructions are provided to said person via Automated Instant Ideograms.

### BRIEF DESCRIPTION OF THE DRAWINGS

In the drawings:

FIG. 1 shows an embodiment diagram of the invention, illustrating the items and the flow of the system and method according to the invention.

FIG. 2 shows another embodiment diagram of the invention, with a different layout/architecture.

FIG. 3 shows an example for analysis of a Video Product's frames in order to provide Automated Feedback Instructions.

### DETAILED DESCRIPTION OF PREFERRED EMBODIMENTS

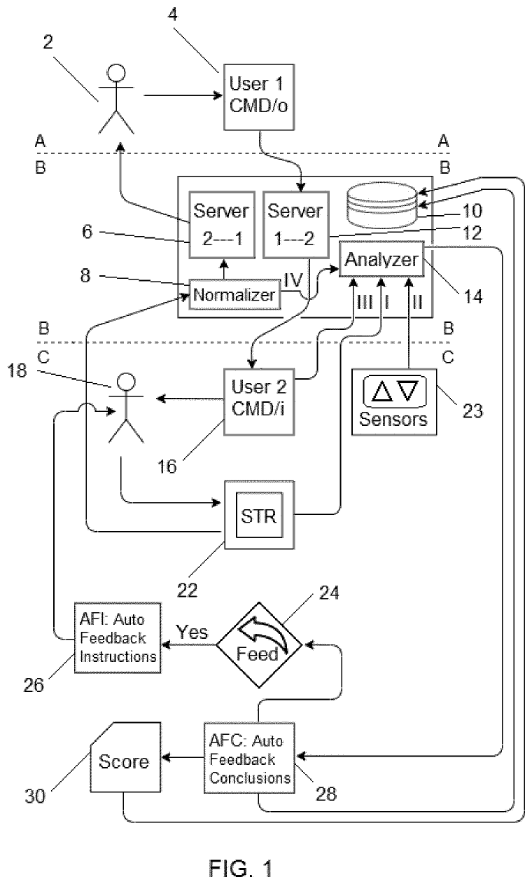

According to the current invention and with a reference to U.S. 63/045,333, Person (2) in FIG. 1 is a Visitor, and person (18) is a Taker. In the broader context of the invention, there are two persons (2) and (18) interacting via the internet. Zone A or the area above line A-A in FIG. 1 relates to the Visitor's environment or domain. Zone C or the area below line C-C in FIG. 1 relates to the Taker's environment or domain. Zone B which is bordered from the top and from the bottom with border lines B-B represents the internet servers which are used for the connection activities between said two persons/domains.

Taker (18) uses the video camera of his mobile device to generate a video streaming, marked as STR (22) in FIG. 1, also referred to as a “Video Product” according to the invention. The quality of said Video Product, and the expected satisfaction or dissatisfaction of the Visitor (2) from such video depends on many video related parameters, also named Video Variables in the context of this invention. Some examples: (a) Is the video stable or is it shaking and vibrating due to unstable hand of the Taker? (b) When the Taker turns—is it done smoothly or with sharp movements? (c) When the Taker zooms in or out, is it done smoothly or with hectic jumps? (d) Are the light levels reasonable or is the video too bright or too dark? (e) Should the video be improved in terms of Gamma Correction? (f) Is the video well focused and sharp?

In addition, the Visit according to U.S. 63/045,333 is active, and the Taker needs to interact with the Visitor by responding to the Visitor's requests. So, the Visitor provides instructions, also referred as User-1-Commands-Output, or in a short writing User-1-CMD/o, as shown in FIG. 1, item (4). Such instructions may be transferred via the Visitor's voice, via texting created by the visitor, and also by innovative means such as Instant Ideograms as further described in U.S. 63/045,333 and in U.S. 63/076,836. Such instructions are forwarded from User 1—the Visitor, to User 2—the Taker, via the Server 1-2 (12). The commands are received by the Taker as shown in FIG. 1 item (16), marked as User 2 CMD//I (User-2-Command-Input). So, in addition to said Video Variables (a) to (f) we can add additional parameters, to be named Response Parameters in the context of this invention, which specifically relate to the way the Taker responds to said instructions by the Visitor. Dome examples: (g) Verify Response: Has the Taker responded at all to a Visitor's request? (h) Response Accuracy: Has the Taker's response to a Visitor request been correct and accurate? (i) Response Time: How fast has the Taker responded to a Visitor's request? Normalizer (8) is a component used to address Video Parameters (a) to (f) and similar Video Parameters, and improve the Video Product on the fly, as further explained. Normalizer (8) is basically an implementation of a common knowledge.

Analyzer (14) is an innovative component of the invention and is used to analyze and process the Response Parameters (g) to (i) and similar Response Parameters, as further explained, as well as additional parameters as further explained, originating from several possible sources.

The Normalizer (8) which relates to analyzing the Video Product in terms of the Video Variables can be handled with existing components of code, possibly Open Source, in addition to a common-knowledge based self-created code. For example, gamma correction, video stabilizing. The Normalizer will implement said common-knowledge Video-Variables improvements and improve the Video Product prior to sending the Video Product via Server-2-1 (6) to the mobile device of the Visitor (2) or the computer monitor of the Visitor (2).

In parallel, the Video Product (22) which is sent to the Normalizer (8) is also sent to the Analyzer (14).

The input to the Analyzer includes 4 sources:

Input I: The video Product (22) itself, as said.

Input II: Data collected from the Taker's device sensors (23) and from the Taker's device GPS.

Input III: The command input (16) which is provided by the Visitor and received by the Taker, and may include voice, text and Instant Ideograms, all according to this invention and to U.S. 63/076,836 and U.S. 63/045,333.

Input IV: Data from the Normalizer relating to the Video Product's defects which have been identified by the Normalizer and corresponding improvements to the Video Product which have been implemented by the Normalizer.

All said 4 input elements III III and IV will be sent to the Analyzer in real time and almost synchronously. Of course, it cannot be 100% synchronously, because different packets sent to the server may be received with small time shifts. It also cannot be 100% synchronously because input element IV is a result of a process that can start only after the Video Product is received (22) so input element IV must have a delay relating to input element I, by definition. But said delays and time shifts are small, are known and can be taken into account by the Analyzer. So, the Analyzer may wait until all data items of type III III and IV relating to a specific point at time or to a specific time slot is available, and then proceed—almost in real time.

Using input elements III III, the Analyzer can address the Response Parameters (g) to (i) and similar Response Parameters. This part of the Analyzer's code will compare the Video Product I with input elements II and III. For example, suppose that the command input (16) at a given point of time was to turn left. The Analyzer code will analyze the Video Product from the point of time in which said turn left command was received by the Taker, and identify:
(A) If the Video Product indicates that such turn occurred, and
(B) How fast was the Taker's response to said instruction to turn left.

Example for general guidelines for implementation of such code which addresses questions like (A) and (B) above will be further explained in Example 1.

The conclusions of such analysis relating to the correlation between the actual Video Product and the Visitor's instructions to the Taker, also defined as Response Recommendations according to the invention, will be used to collected at the Auto Feedback Conclusions component (28) (further named AFC). Such Response Recommendations relating to the Taker's performance can be used for feedback provided to the Taker, as well as for grading the Taker's performance. Since all is done almost in real time, such feedback, when valuable, may be provided to the Taker via the Automated Feedback Instructions component (26) (further named AFI). So any Auto Feedback conclusion as collected in component (28), if marked by code component (24) as a message that should be delivered to the Taker, will be forwarded to the AFI component (26). Component (24) may decide not to deliver messages from the AFC to the AFI. For example, if the Taker performs well and the AFC collects a series of Auto Feedback conclusions which are all indicating an excellent response by the Taker to the Visitor's instructions, it will be enough to forward only some of these feedbacks from the AFC to the AFI, to eliminate a repetitive message of approval to the Taker. All feedbacks are collected in the AFC (28) and used for the Auto Score (30), but there is no need to send repetitive approval feedbacks to the Taker via the AFI (26), as it will make an unnecessary overload of feedbacks on the Taker. The AFI code component (26) will provide feedback to the Taker either via digital voice or via text message or via special Instant Ideograms that will be initiated by the software automatically instead of by the Visitor, further referred to as Automated Instant Ideograms. For example:
(Feedback x1) Digital voice: “Please pay attention and respond to turn—left and turn—right requests” or (x2) Digital voice: “Please note that you've ignored a turn instruction”.
(Feedback y1) Pop up text message: “Your response to the Visitor's requests are excellent” or (y2) an Automated Instant Ideogram which looks like a circle with a ‘v’ sign in it or (y3) an Automated Instant Ideogram which looks like a circle with the number 100 written in it.

Using input elements IV, the Analyzer can also collect conclusions and recommendation relating to the Video Variables (a) to (f) and similar Video Variables, which are also provided to the AFC component (28), and possibly to the AFI component (26). So, this source IV will also be used to collect conclusions relating to the Taker's performance, which can be used for feedback to be provided to the Taker via the AFI. For example:
(Feedback z) Digital voice: “When you zoom in, please do it more smoothly”
(Feedback w) Digital voice: “Try to stabilize your device”

As can be seen from these examples, the Automated Feedback Instructions of the AFI component (26) can relate both to the Response Parameters (Feedback (x) and (y) above) and to the Video Product by itself (Feedbacks (w) and (z) above). In addition, it should be noted, as seen by this example, that messages of approval such as (y) may be provided, and not only critic messages.

Whether Automated Feedback Instructions are provided by the AFI component (26) to the Taker or not, all Automated Feedback Instructions Conclusions are collected (28) and used to generate an Automated Score (30) of the Taker for the specific Visit. This score should not be confused with an additional score which will not be automatic but will be provided by the Visitor directly.

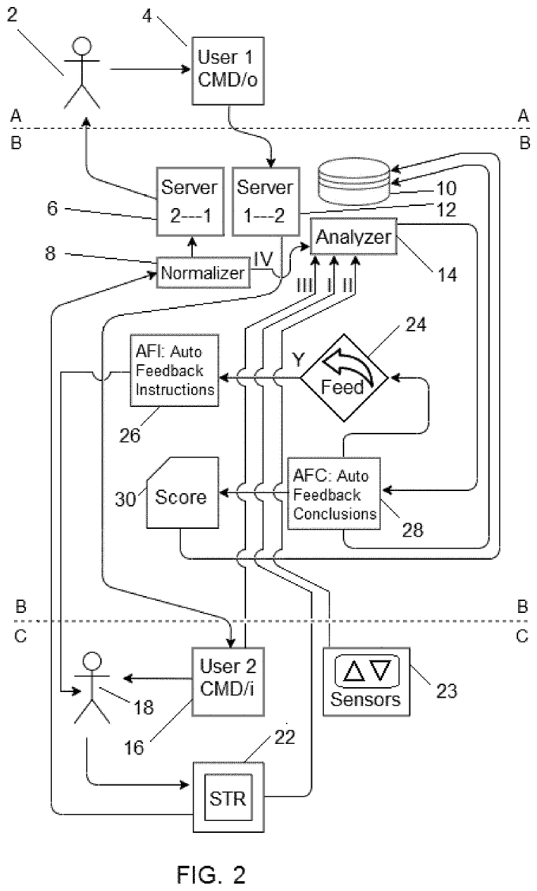

The Collected data of the AFC (28) and Score (30) which, according to FIG. 1 are generated by a code component that is located beyond dashed line C-C, i.e. at the Taker's domain, i.e. the app at the Taker's device, will be sent back via the internet to the server and stored on database (10). In another embodiment, as shown in FIG. 2, code elements (24), (26), (28) and (30) are located at the server, and the Automated Feedback Instructions (26) are sent via the internet to the Taker (18).

The method of the invention will be further explained and demonstrated hereby with an example.

### Example 1

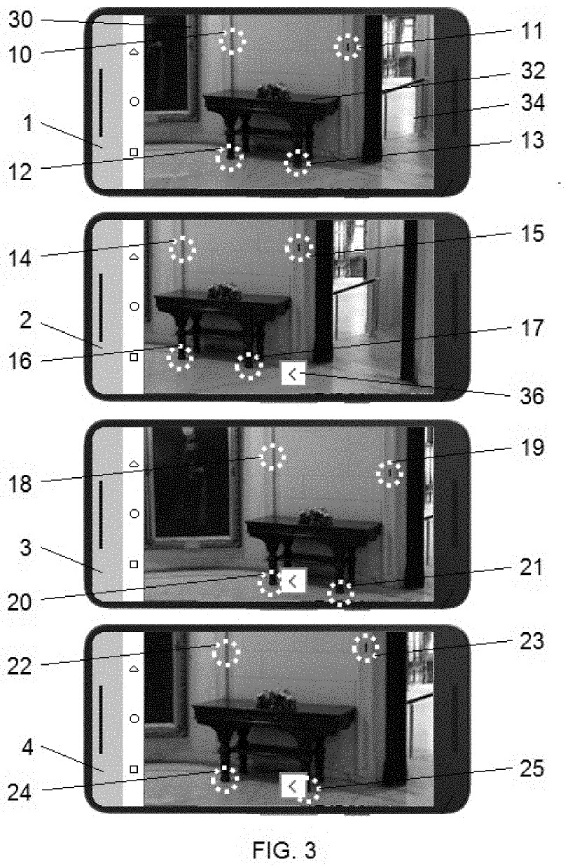

FIG. 3 illustrates an example in which a Visitor receives a Video Product from a Taker, and at the beginning of this example the Visitor sees the frame shown at device (1). In this frame, a table (32) is seen at the middle of the frame, a painting (30) to the left and a door (34) to the right. At this point, according to the current example, the Visitor sends an Instant Ideogram (36) to the Taker, requesting the Taker to turn left. Mobile devices (2), (3) and (4) indicate 3 possible responses by the Taker. As can be seen from the video frame at device (2), the table is now located to the left of its original location, which can be seen in device (1). This implies that the Taker turned to the right. So, in this case, the Taker made a mistake and turned to the right instead of to the left, as requested. This mistake of the Taker can be automatically identified by a computer code of the Analyzer (item 14 in FIG. 1, FIG. 2), and used for feedback purposes, using the following sequence of operations:
(a) Identify when an Instant Ideogram “turn left” (36) is sent to the Taker.
(b) Capture the video frame at this point of time in which said Instant Ideogram has been sent. (In this example, the frame as seen on device (1) in FIG. 3
(c) Wait 1500 msec (1.5 sec).
(d) Capture again the video frame.
(e) Identify 4 unique features in the original frame (b above). The code will split the screen to 4 quarters and will find 4 different features, each in a different quarter. In this example: two edges of the table's legs (12) and (13), vertical line at the wall (10) and vertical dark strip (11). Identifying such features and the corresponding x-y locations of their pixels is a common knowledge in computer vision, and it can be done by identifying typical groups of pixels with typical unique layouts of RGB colors.
(f) Identify said unique features (which have been found in e above) at frame (d) and see the change in x-y location (if any). (Note, in frame (d), said 4 unique features are no longer necessarily located in 4 different quarters of the frame).
(g) Assuming that the video frame of item (d) above, as captured, is as seen in device (2): compare the location of features (10), (11), (12), (13) as seen at device (2) to the corresponding location of said features in (b) above. This means identify the x and y locations of some of the pixels' patterns of each of said 4 features. In this example, all said features (10), (11), (12), (13) moved to the left. For example, a pixel belonging to pattern (12) may have moved from (1025, 215) (in b as seen in device 1 FIG. 3) to (747, 200) (in d as seen in device 2 FIG. 3, new location (16)), which is a significant move to the left. Note: since video capturing is dynamic by nature, a RGB pattern may slightly change due to different angles, light sources, and shadows, etc. But all this is a common knowledge, and it is easy to track a typical pattern of pixels even when they slightly change in size/layout/RGB values. Therefore, identifying such features and a change in their locations on the screen are, as said, a common knowledge in computer vision.
(h) If said features/patterns (10), (11). (12), (13) have all clearly moved to the left, i.e. their x coordinates decreased significantly, it is an indication that the Taker moved to the right.
(i) Send the following feedback string to the AFC component which collects the feedbacks (item 28 in FIG. 1, FIG. 2): “Operation required: turn left. Operation executed: turn right”.
(j) Since said executed operation did not match the requested operation, the system decides (element (24) in FIG. 1, FIG. 2) to forward the feedback to the AFI component (26).
(k) The AFI (item (26) in FIG. 1, FIG. 2) component generates an Automated Feedback Instruction, in this example a message to be provided to the Taker via digital voice or text: “Note, you turned right instead of turning to the left as requested”.
(l) Based on (i) update the accumulative automated score of the Taker (item 30 in FIG. 1, FIG. 2). In this example the score added will be low as the Taker has not responded correctly.

However, if the video captured at item (d) above is as seen at device (3) in FIG. 3 (and not at device (2)), then items (g) to (1) above will be replaced with the following:
(g) Assuming that the video frame of item (d) above, as captured, is as seen in device (3): compare the location of features (10), (11), (12), (13) as seen at device (3) to the corresponding location of said features in (b) above. This means identify the x and y locations of some of the pixels' patterns of each of said 4 features. In this example, all said features moved to the right. For example, a pixel belonging to pattern (12) may have moved from (1025, 215) (in b as seen in device 1 FIG. 3) to (1611, 201) (in d as seen in device 3 FIG. 3, new location (20)), which is a significant move to the right.
(h) If said features/patterns (10), (11). (12), (13) have all clearly moved to the right, i.e. their x coordinates increased significantly, it is an indication that the Taker moved to the left.
(i) Send a feedback string to the AFC component which collects the feedbacks (item 28 in FIG. 1, FIG. 2): “Operation required: turn left. Operation executed: turn left”.
(j) Since said executed operation did match the requested operation, the system decides (element (24) in FIG. 1, FIG. 2) not to forward the feedback to the AFI component (26).
(k) Based on (i) update the accumulative automated score of the Taker (item 30 in FIG. 1, FIG. 2). In this example the score added will be high as the Taker has responded correctly.

Yet however, if the video captured at item (d) above is as seen in device (4) in FIG. 3, then items (g) to (1) above will be replaced with the following:
(g) Assuming that the video frame of item (d) above, as captured, is as seen in device (4): compare the location of features (10), (11), (12), (13) as seen at device (4) to the corresponding location of said features in (b) above. This means identify the x and y locations of some of the pixels' patterns of each of said 4 features. In this example:
   The feature at the top left quarter ((10) in device (1)) moved to the left ((22) in device (4); and
   The feature at the bottom left quarter ((12) in device (1)) moved to the left ((22) in device (24); and
   The feature at the top right quarter ((11) in device (1)) moved to the right ((23) in device (4); and
   The feature at the bottom right quarter ((13) in device (1)) moved to the right ((25) in device (24).
(h) Since the two left features/patterns have moved to the left, i.e. their x coordinate decreased, and the two right features/patterns have moved to the right, i.e. their x coordinate increased, it is an indication that the Taker did not move to the left neither to the right, but moved forward.
(i) Send a feedback string to the AFC component which collects the feedbacks (item 28 in FIG. 1, FIG. 2): “Operation required: turn left. Operation executed: move forward”.
(j) Since said executed operation did not match the requested operation, the system decides (element (24) in FIG. 1, FIG. 2) to forward the feedback to the AFI component (26).
(k) The AFI (item (26) in FIG. 1, FIG. 2) component generates an Automated Feedback Instruction, in this example a message to be provided to the Taker via digital voice or text: “Note, you have ignored a turn left text request. Please pay attention to text requests or ask the Visitor to use voice requests instead or to use Instant Ideograms requests instead”.
(l) Based on (i) update the accumulative automated score of the Taker (item 30 in FIG. 1, FIG. 2). In this example the score added will be low as the Taker has ignored a request.

It should be noted that the period of 1500 msec in item (c) above is an example. The time may be different. It should also be noted that for extra accuracy, all the stages following stage (c) may be repeated several times, with increasing periods at each time, as in the following example:
(c) Wait 1000 msec (1.0 sec).
(d) Capture again the video frame.
   Continue with all next stages (starting (e)).
(c) Wait 1500 msec (1.5 sec).
(d) Capture again the video frame.
   Continue with all next stages.
(c) Wait 2000 msec (2.0 sec).
(d) Capture again the video frame.
   Continue with all next stages.

By repeating the process 3 time, as in the example above, the accuracy of the algorithm is enhanced, as we verify the Auto Feedback Conclusion 3 times.

While some embodiments of the invention have been described by way of illustration, it will be apparent that the invention can be put into practice with many modifications, variations and adaptations, and with the use of numerous parameters that are within the scope of persons skilled in the art, without departing from the spirit of the invention or exceeding the scope of the claims.

The invention claimed is:

1. A computer implemented method for providing automated feedback to a person who generates Video Products, so that said automated feedback may help said person to improve his Video Products, comprising the elements of:
a) A Video Product generated by said person;
b) Reference data relating to said Video Product and originated from at least one source;
c) Analyzer which correlates elements of (a) with corresponding elements of (b) in order to generate Automated Feedback Conclusions (AFC); and
d) Means to collect said AFC and provide them to said person when needed by Automated Feedback Instructions (AFI).

2. Method according to claim 1 which is implemented on-the-fly, therefore it provides said person with Automated Feedback Instructions relating to a previous part of said Video Product while said person is generating additional parts of said Video Product.

3. Method according to claim 1 in which said Automated Feedback Instructions are provided to said person after completing a video Product so that said person can implement the Automated Feedback Instructions when generating next Video Products.

4. Method according to claim 1 in which said source of reference data is Instant Ideogram instructions provided to said person over the internet by another person.

5. Method according to claim 1 in which said source of reference data is oral instructions provided to said person over the internet by another person.

6. Method according to claim 1 in which said source of reference data is text instructions provided to said person over the internet by another person.

7. Method according to claim 1 in which said source of reference data is data from the sensors of a mobile device of said person which is used to generate the Video Product.

8. Method according to claim 1 in which said source of reference data is data from the GPS of a mobile device of said person which is used to generate the Video Product.

9. Method according to claim 1 in which said source of reference data is computer code's analysis of the Video Variables of the Video Product itself.

10. Method according to claim 1 in which said improvement of Video Product leads to higher automated scoring for said person.

11. Method according to claim 1 in which said person is a Taker and said source is a Visitor and said reference data is the instructions provided by the visitor to the Taker.

12. Method according to claim 10 in which said improvement of Video Product leads to higher score granted by said Visitor to said Taker.

13. Method according to claim 1 in which said Automated Feedback Instructions are provided to said person via automated digital voice.

14. Method according to claim 1 in which said Automated Feedback Instructions are provided to said person via automated text.

15. Method according to claim 1 in which said Automated Feedback Instructions are provided to said person via Automated Instant Ideograms.
